(19) United States
(12) Patent Application Publication
(10) Pub. No.: US 2006/0262947 A1
(43) Pub. Date: Nov. 23, 2006

(54) Multi-purpose torch speaker

(76) Inventor: Shaoming Liang, Jiangmen (CN)

Correspondence Address: Mr. Eric Chan, 42 Pin Oaks Drive, Phoenixville, PA, 19460, US

(21) Appl. No.: 11/134,440

(22) Filed: May 23, 2005

(51) Int. Cl. H04R 5/02

(52) U.S. Cl. 381/300

(57) ABSTRACT

This invention has given birth to a new type of multi-purpose flashlight speaker, which is structurally compact, easy to install and multi-functional. It contains an illuminator, external cover, switch, battery, microphone, circuit board and a volume adjustor as well as a loudspeaker. The external sound cartridge is installed on the front of the external cover, and the loudspeaker is fixed on the back of the external sound cartridge, where it is opposite the reflection cartridge, and the loudspeaker through the external sound cartridge fastens the internal sound cartridge. The illuminator is built on the front of the reflection cartridge. This special type of speaker is not only featured with the ability to speak, but also with the illuminating, alarming, power indicating and radio features, so it is an ideal choice in various situations and especially amid weak light circumstances. Between the left and the right cover are the batteries, circuit board, various switches, volume adjustors, radio and mosquito repellent etc, so it is very convenient to install these objects.

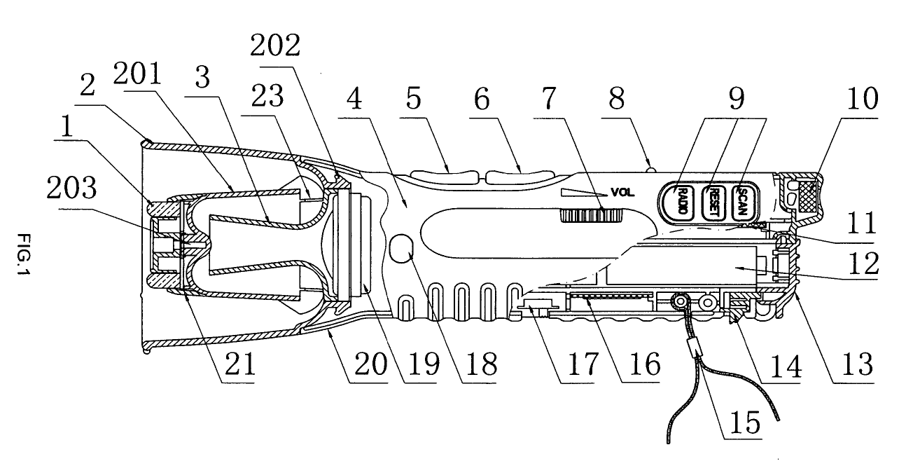

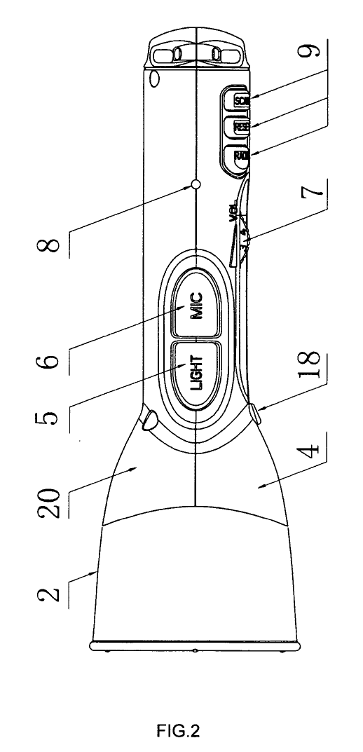

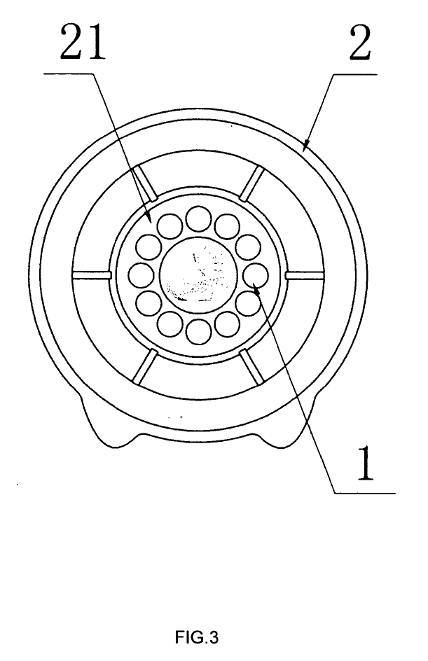

### BACKGROUND OF THE INVENTION

This patent involves a multi-purpose flashlight speaker, an invention of portable speaker.

This new speaker comprises a front external cover, a back external cover, reproducer, power supply, microphone, magnified circuit and the switch and a volume adjustor. The front of the cover rests the loudspeaker, with a resonance cartridge inside for reflecting the sound. The microphone for collecting sound is installed on the back of the cover, and when the sound enters the microphone, the sound wave shall be changed into electric signal, which shall be transformed to sound wave through the loudspeaker after being magnified by the magnified circuit. The sound wave will then, be reflected and given out by the speaker.

The automated microcomputer speaker, released on Dec. 30th, 1992 and with the patent number CN2126493U, contains a sound collector, power supply, power amplifier, a loudspeaker and calculation amplifier, language processor and a memorizer as well as a recording-playing controller. The connection exists between the picking-up cartridge and calculation amplifier, the calculation amplifier and language processor, the language processor and the memorizer, the recording and playing controller and language processor, the calculation amplifier and power amplifier, the power amplifier and loudspeaker. The power supply connects the power amplifier, calculation amplifier, language processor and the memorizer respectively. This type of speaker is limitedly functional and thus not easy to use.

### BRIEF SUMMARY OF THE INVENTION

This invention has helped us solve the problems of current speakers, including the singularity of function and inconvenience for carrying as well as the difficulty of installing, but given birth to a new type of multi-purpose flashlight speaker, which is easy to use and has many functions.

The technology scheme is as follows: multi-purpose flashlight speaker, including its illuminant, external cover, loudspeaker, power supply, microphone, magnified circuit, switches and volume adjustor. A spotlight is equipped inside the front cover. The external cover described includes a loudspeaker cartridge, handle and back cover. To be more specific, two parts, the right and the left side, cover the handle and the two sides are bolted together. The loudspeaker and the handle, the handle and the back cover, are also joined together by bolts, which has simplified the external cover of the speaker. A space on the back cover has been left for placing volume adjustor. Furthermore, the picking-up cartridge takes the straight shape and a battery cartridge in the handle is also available.

Two arm-brace has been available under the front part of the loudspeaker cartridge, which shall be used to uphold the speaker along with the handle. Besides, a radio and a recorder as well as an annunciator are installed inside the external cover.

The speaker cartridge and its handle are bolted together through the holes on the joining armor plates, which are behind the banding holes on the right and left side of the speaker.

Special effects: the speaker could be used both as torchlight and speaker after being turned on. Besides, people are also able to use the speaker as an alarming apparatus, mosquito repellent, radio and recorder, which could be recharged when facing power shortage by giving out shortage indication. In addition, it's structurally simple. Therefore, it is an ideal choice in many situations.

### BRIEF DESCRIPTION OF THE DRAWINGS

Drawing 1: the cutaway view of the flashlight speaker

Drawing 2: planform of the flashlight speaker

Drawing 3: right side-viewed drawing

According to the graphics, 1 light diode, 2 external sound cartridge, 201.reflection cartridge, 3. internal sound cartridge 23. band, 202. band,4 [symbol] left cover, 5.luminance switch, 6.amplifier switch, 7. volume knob 8.indicator 9.radio switch 10.microphone 11.circuit board 12.battery 13.battery cover 14.lock cover 15.suspension rope 16.mosquito repellent 17.mosquito repelling switch 18.alarming switch 19.loudspeaker 20.right cover 21.supporter 203. Screw

### DETAILED DESCRIPTION OF THE INVENTION

Drawing 1 includes a three-dimensional analysis of the implementation of multi-purpose speaker. According to the 1,2 and 3 drawing, the multi-purpose flashlight speaker comprises a external sound cartridge 2, left cover 4, right cover 20 and a battery cover 13, among which the external sound cartridge 2 and the reflection cartridge 201 are bound together by band 23. The light diode 1 is bolted on pedestal 21. The internal sound cartridge 3 goes through the back of the external sound cartridge 2, and loudspeaker 19 is installed on the back of the external sound cartridge 2 pressing the internal sound cartridge 3. The external sound cartridge 2 is bolted between the left external cover 4 and the right external cover 20, by placing the band 202 on the external sound cartridge 2 opposite the inner slot on the left cover 4 and the right cover 20. On the middle of the external cover builds the illuminating switch 5 and amplifier switch 6, respectively controlling the illuminating circuit and the amplifier circuit. There is an indicator light 8 on the backside of the external cover, and it will go on when the switch is turned on, being green during normal voltage and red when facing low voltage. The microphone 10 is placed on the back of the external cover, and when the switch 6 is on, the sound signal will be amplified by the amplifier circuit and emitted through speaker 19. The mosquito-repelling switch 17 is installed under the external cover and it will give out a sort of signal of special frequency so as to attain the end of killing or driving off mosquitoes. There is a hanging rope 15 under the right external cover 20. The alarming button 18 is built on the middle part of the front of the left external cover 4 and on the left external cover fixes the volume adjusting knob and relevant marks. The radio switch 9 is built on the back of the left external cover 20, and people can tune in by pressing different buttons and when the reposition button is pressed, the radio will go back to its first channel. Between the left and the right cover installs the circuit board 11, which is fastened by both covers. A battery box 12 for four is under the circuit board 11, followed by the battery cover 13, whose both sides are fastened together by the left and the right covers. The lock to the battery cover fixes under the back of the external cover, pressed by spring to protect the battery cover from opening up. To change the batteries, the battery lock needs first of all opened.

The illuminant described here refers to light diode.

What is claimed is:

1. This multi-purpose flashlight speaker comprises an illuminator, external cover, switch, battery, microphone, circuit board, volume adjustor and loudspeaker. The external sound cartridge is installed on the front of the external cover, and so is the loudspeaker. The loudspeaker through the external sound cartridge fastens the internal sound cartridge and the illuminator is installed on the front of the reflection cartridge. The pedestal and the illuminator are bolted together.

2. The external cover is composed of the left and the right covers as well as the battery cover. Multi-purpose flashlight speaker, including its illuminant, external cover, loudspeaker, power supply, microphone, magnified circuit, switches and volume adjustor. A spotlight is equipped inside the front cover. The external cover described includes a loudspeaker cartridge, handle and back cover.

3. According to the first and the second requirements, which have described the features of this multi-purpose flashlight speaker, between the loudspeaker and the reflection cartridge is an internal sound cartridge, which is bolted on the middle of the external sound cartridge. The external cover includes radio, alarming apparatus, mosquito repellant, among which the volume adjusting button projects out of the external cover.
